(19) United States
(12) Patent Application Publication
(10) Pub. No.: US 2003/0220112 A1
(43) Pub. Date: Nov. 27, 2003

(54) System and method for enabling the use of spatially distributed multichannel wireless access points/base stations

(75) Inventor: Alex Bugeja, Acton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Engim, Incorporated, Acton, MA

(21) Appl. No.: 10/339,794

(22) Filed: Jan. 9, 2003

Related U.S. Application Data
(60) Provisional application No. 60/349,173, filed on Jan. 16, 2002.

(51) Int. Cl. H04Q 7/20

(52) U.S. Cl. 455/446; 455/456.1

(57) ABSTRACT

A system and method are provided for enabling the use of spatially distributed multichannel wireless access points or base stations. There is enabled a setup which allows frequency reuse whilst still giving many clients around the access points access to the multiple channel capability of each access point. This allows larger overall communication bandwidths to be obtained on average, even within the constraints of frequency reuse.

### RELATED APPLICATION

This application claims the benefit of U.S. Provisional Application No. 60/349,173, filed Jan. 16, 2002. The entire teachings of the above application are incorporated herein by reference.

### BACKGROUND OF THE INVENTION

A wireless Local Area Network (LAN) protocol allows mobile clients to find other mobile clients and access points, register with the wireless LAN and exchange data with other mobile clients and access points. One such wireless LAN protocol is the Institute of Electrical and Electronics Engineers (IEEE) 802.11b protocol which supports clients roaming within buildings such as, homes, offices, hotels and airports using direct sequence spread spectrum radios with data rates up to 11 Mb/s in the 2.4 GHz band.

The number of available frequencies for communicating with clients within a wireless LAN band is limited. However, the capacity of the wireless LAN can be increased through a frequency reuse scheme. Instead of having one large base station known as an access point (AP) in a wireless LAN, cover an entire service area, the service area is divided into a plurality of small coverage areas or “cells”, with each cell having an access point at the center. In order to minimize interference between cells, available frequencies in the band are allocated to each cell in a repeating pattern such that adjacent cells are not assigned the same frequency.

For example, the IEEE 802.11b protocol which operates in the 2.4 GHz band has adequate spectrum to provide three independent channels, each having a different center frequency. Each access point is configured to operate on a channel which does not interfere with the channel assigned to an adjacent access point. A client switches between the available channels in order to communicate with the access point having the best signal strength.

FIG. 1 illustrates a prior art wireless Local Area Network 104 having a plurality of single channel access points 102 configured for a conventional frequency reuse scheme. Each access point 102 is shown at the center of a cell 100. The cell 100 represents the coverage area within which a client can communicate with the access point 102. There are three available channels having center frequencies of 1, 6 and 11 in the wireless Local Area Network 104. The available frequencies have been assigned to access points 102 based on the conventional frequency reuse scheme such that access points 102 in adjacent cells 100 are not assigned the same frequency, in order to reduce interference between cells 100.

There is a finite bandwidth available for communicating with an access point which is shared by all mobile clients within the cell 100. The access point 102 communicates with the mobile client based on signal strength detected by the client on the channel assigned to the access point. A client transmits a request to communicate on each available frequency and communicates with the access point that responds based on the strength of the signal received by the client. Thus, each client communicates with the access point having the highest signal strength. As the number of clients close to a particular access point 102 increases, the bandwidth available for clients within the cell 100 decreases accordingly. For example, with two clients communicating with an access point, each gets half the available bandwidth for the channel assigned to the access point.

### SUMMARY OF THE INVENTION

A method and apparatus for increasing available bandwidth to mobile clients in a wireless local area network is provided. A wireless access system includes multiple cells. Each cell has one or more primary channels with adjacent cells having different primary channels. An access point within a cell transmits at lesser power on a secondary channel exclusive of the primary channel and assigns channels to wireless clients.

The access point may sense relative distance of clients and assign secondary channels to closer clients. The access point may sense power to sense relative distance. Clocks in each access point may be synchronized, allowing the access point to expand the secondary channels to fill the cell for a limited time agreed upon with other access points. The access point or the client retransmits, upon detecting a collision of its transmission with transmissions from other clients or access points. Collisions may be reduced by limiting transmission by the client to a pre-determined time slot.

The wireless access system may include multichannel clients which transmit over all channels simultaneously in the inner region of the cell. A multichannel client is restricted to primary channels in an outer region of the cell.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a prior art wireless Local Area Network having a plurality of single channel access points configured for a conventional frequency reuse scheme;

FIG. 2 illustrates three independent channels within the 2.4 Ghz band;

FIG. 3 illustrates a wireless Local Area Network having a plurality of cells, each cell having a multi-channel access point at the center;

FIG. 4 illustrates a wireless Local Area Network having a plurality of multi-channel access points configured for a frequency reuse scheme according to the principles of the present invention;

FIG. 5A is a graph illustrating a typical distribution of data exchanges between an access point and clients;

FIG. 5B illustrates a further increase of available bandwidth by expansion of secondary channels into the outer region of a cell for a limited time period;

FIG. 6 illustrates the particular case of a client located on the boundary of two cells;

FIG. 7 illustrates a multichannel client located within the inner region of a cell which can perform multichannel communications with the access point;

FIG. 8 is a block diagram of a typical access point which performs a bridging function between a wireless network and a wired network; and

FIG. 9 is a block diagram of an embodiment of the wireless network interface shown in FIG. 8; and

FIG. 10 is a block diagram of another embodiment of the wireless network interface shown in FIG. 8.

### DETAILED DESCRIPTION OF THE INVENTION

A description of preferred embodiments of the invention follows.

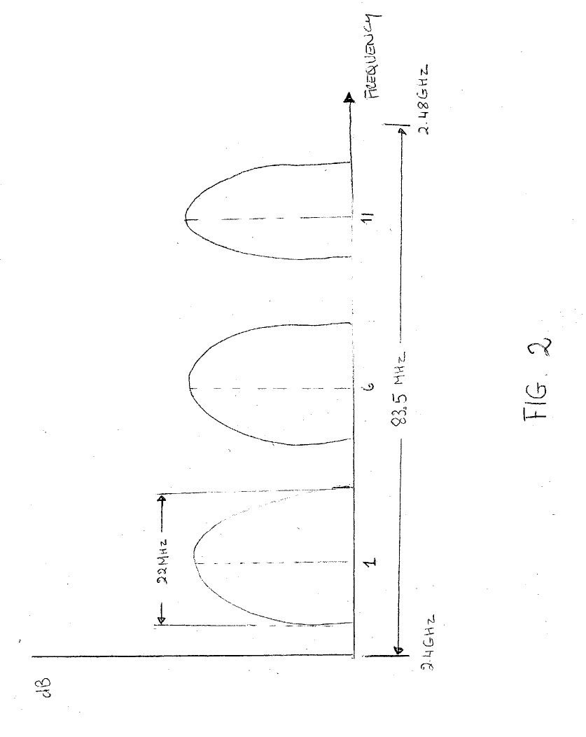

Several wireless communication protocols and their associated bands allow communication systems to simultaneously use multiple channels within the band. FIG. 2 illustrates three independent channels within a 2.4 GHz band. For example, three IEEE 802.11b channels can be independently transmitted and received at data rates up to 11 Mbps within the 2.4 GHz Industrial, Scientific and Medical (ISM) band in the United States. The IEEE 802.11b standard provides fourteen overlapping channels of 22 MHz in an 83.5 MHz range between 2.4 GHz and 2.48 GHz, with channel centers spaced about 5 MHz apart. The 83.5 MHz range, referred to as the 2.4 GHz band can accommodate three non-overlapping 22 MHz channels simultaneously. The center frequencies for three (1, 6, 11) of the 14 overlapping 22 MHz channels are chosen to provide the three independent non-overlapping 22 MHz channels. Thus, bandwidth to an access point is increased by allowing clients to communicate on three independent channels simultaneously.

The three channels in the IEEE 802.11b standard provide the minimum number of channels required for a two-dimensional frequency re-use scheme to eliminate interference between adjacent cells. Channels 1, 6, 11 of the 14 channels are used in the United States due to FCC requirements. In Europe, Channels 1, 7 and 13 are typically used.

In an alternate embodiment, the IEEE 802.11a protocol can be used to communicate between mobile clients and access points. The IEEE 802.11a protocol uses a different portion of the frequency spectrum (the 5 GHz Unlicenced National Information Structure (UNII) band) and provides eight center frequencies with data rates up to 54 Mbps between 5.15 and 5.35 GHz. The eight channels can be distributed among the cells to limit interference between cells and maximize available bandwidth to clients in each cell in a similar way as discussed for the three available channels in the IEEE 802.11b standard.

The invention is not limited to wireless LANs using the IEEE 802.11a or IEEE 802.11b protocol. The invention can be used in any wireless protocol in which the available bandwidth is shared by clients operating on different frequencies, and which allows clients to change channels.

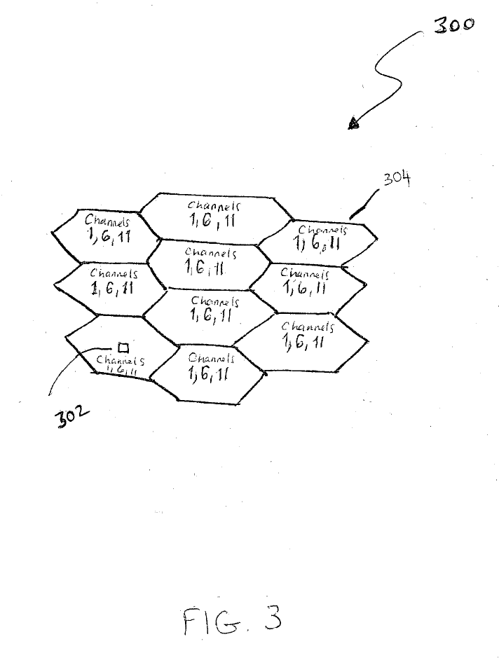

FIG. 3 illustrates a wireless Local Area Network 300 having a plurality of cells 304, each cell having a multi-channel access point 302 at the center. The cell 304 represents the coverage area within which a client can communicate with a particular multichannel access point. In an IEEE 802.11b wireless Local Area Network, each access point has a small coverage area, typically in the order of about 300 feet radius from the access point if there are no obstructions. There are three available channels with respective center frequencies 1, 6 and 11 in each multichannel access point 302 in the wireless Local Area Network 300. Each multichannel access point 302 can communicate with clients within the cell 304 on any of the three available channels. For example, with only three clients within the cell, each client can communicate with the multichannel access point on a different channel. However, with each multi-channel access point communicating simultaneously on the same three channels, interference between adjacent cells can result.

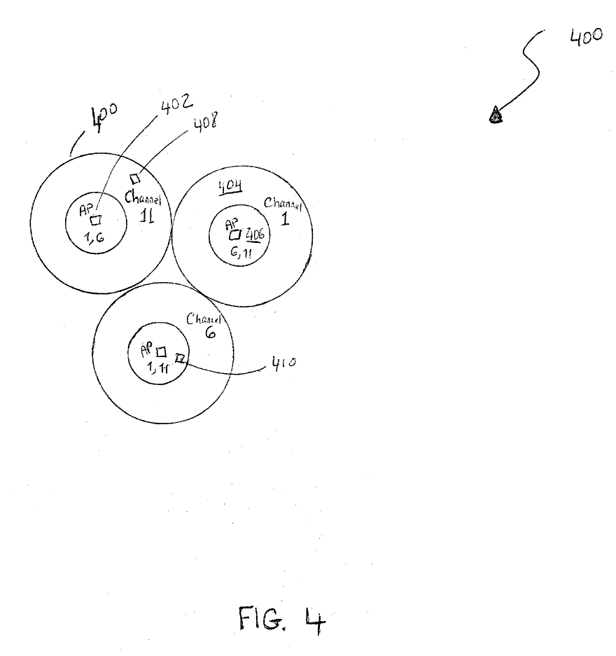

FIG. 4 illustrates a wireless Local Area Network 400 having a plurality of multi-channel access points 402 configured for a frequency reuse scheme according to the principles of the present invention. One embodiment of the system is illustrated in FIG. 4 in the context of a wireless Local Area Network based on the IEEE 802.11b protocol 2.4 GHz ISM band. However, the invention is not limited to a wireless Local Area Network based on the IEEE 802.11b protocol 2.4 GHz ISM band; the invention is applicable to all wireless networks including cellular.

Three multichannel access points 402 are shown in the center of cells 400 in FIG. 4. Each client 408 can transmit and receive channels having center frequencies 1, 6 and 11 within the ISM band as discussed in conjunction with FIG. 2.

The multichannel access point 402 is at the center of each cell 400. The cell 400 represents the coverage area within which a client 408, 410 can communicate with a particular multichannel access point 402. There are three available channels (1, 6 and 11) in each multichannel access point 402 in the wireless Local Area Network 300. The multichannel access point 402 controls each channel in terms of power transmitted. A frequency reuse scheme is implemented by configuring each multichannel access point 402 to transmit on full power on a primary channel and on less power on secondary channels. The transmission at different power levels results in the partitioning of each cell 400 into two regions, an outer region 404 and an inner region.

Clients generally transmit at full-power and use the channel that the multichannel access point 402 assigns for transmitting. The client typically hops among the available channels until it receives a response from an access point. On each hop, the client emits a “beacon” signal to signal its presence to an access point. Access points typically have some form of power detection to determine whether to accept transmission from a client. The access point will not accept transmission from a client if the signal is too weak indicating that the client is too far away from the access point. The client hops to another frequency to attempt to find an access point until assigned a channel.

The multi-channel access point 402 assigns channels based on detected signal strength. Channel assignment in the IEEE 802.11 protocol can be performed by refusing to communicate with the client on a particular channel and waiting for the client to hop to a better channel before responding. Thus, client 408 in the outer region 404 is assigned to the primary channel. A client 410 in the inner region 410 is assigned the primary channel or any of the secondary channels, but likely one of the secondary channels to free the primary for peripheral clients. Thus more bandwidth is available for clients in the inner region 410 close to the access point. Communication in the outer region 404 is assigned to the primary channel to minimize interference between channels assigned to the outer regions 404 of adjacent cells 400.

The two secondary channels in the inner region 406 are transmitted at about half power so as not to cause interference with adjacent cells 400. The primary channel in the outer region 404 is transmitted at full power to provide coverage for the entire cell. The frequency of the primary channel for each cell 400 is selected so as not to interfere with the primary channels of adjacent multichannel access points. A client 410 located within the inner region 406 can communicate on all three channels. A client in the outer region 404 communicates only with the full power primary channel.

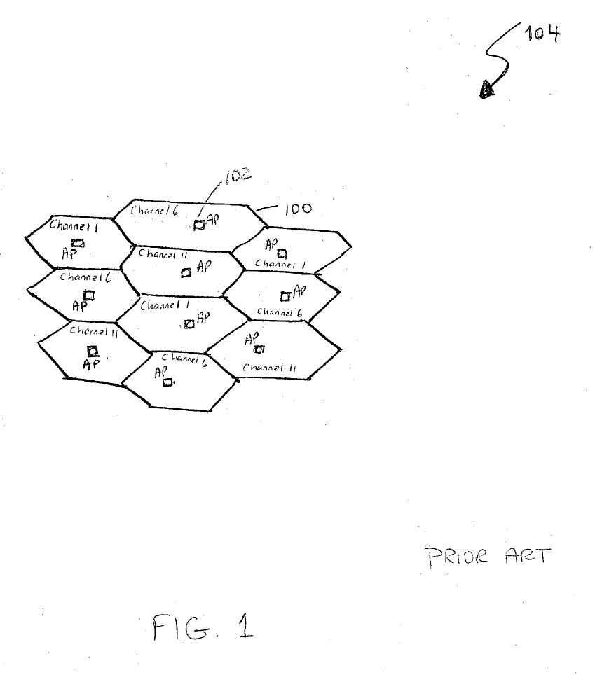

In the embodiment shown, two secondary channels in each multichannel access point 402 are transmitted at half the maximum power, while a primary channel is transmitted at full power. The primary channel transmitted by each multichannel access point 402 is selected based on a conventional frequency reuse pattern for single channel access points as described in conjunction with FIG. 1.

Based on the detected power level, the access point determines whether the mobile client is in the inner region 406 or the outer region 404. If the client is in the inner region 406, the client may be assigned to channel 1, 6 or 11. The client is likely assigned to channel 1 or 6 in the inner region to give more bandwidth on channel 11 to the outer region 404. If the client is in the outer region 404 and channel 11 is the primary channel of the cell, the client is assigned to channel 11. Thus, clients in the inner region 406, with three available channels receive more bandwidth. With two clients, each client can be assigned to a different channel and each receives 100% of the available bandwidth of the assigned channel. Clients in the outer region 404 share the bandwidth of the full-power channel, which will be greater bandwidth than the conventional frequency reuse scheme since some clients (in the inner region) are on channel 1 and channel 6.

The assignment of primary and secondary channels to access points is performed manually or through intelligent automatic algorithms which synchronize access points through the wired backplane or over wireless channels. Such algorithms are well-known to those skilled in the art.

Transmitting primary channels at full power and secondary channels at half power minimizes interference between access points as in conventional frequency reuse, with the additional benefit of multiple channels within the inner region 406 for increased bandwidth. In addition, clients within the inner regions 406 around each access point can operate multichannel and take advantage of three times speed downloads and uploads to the access points by bonding channels together if they are equipped to do so. Furthermore, clients in the outer region 404 also benefit because they have reduced bandwidth sharing in general with other clients in the inner region 406 who can be shifted to other channels.

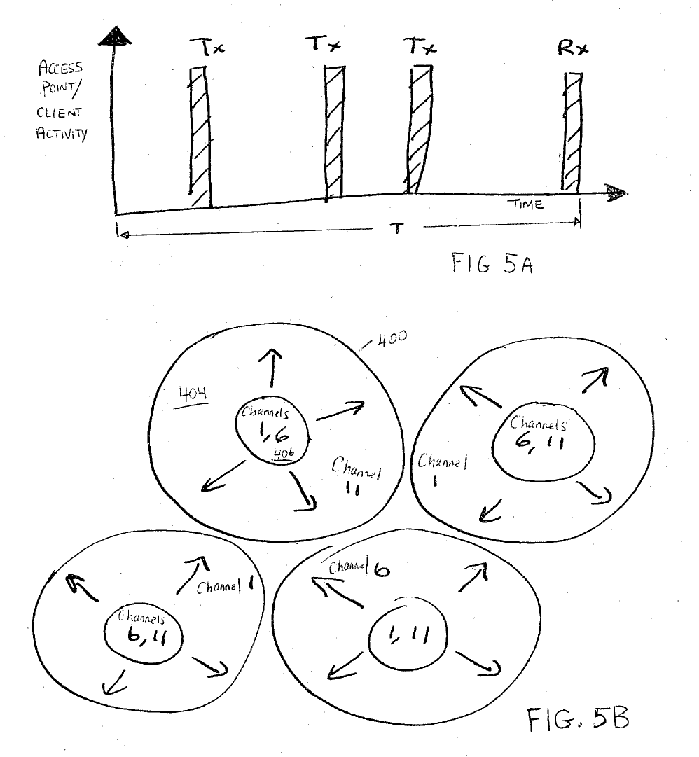

FIG. 5A is a graph illustrating a typical distribution of data exchanges between an access point and clients. Data exchanges in wireless LANs are bursty in nature, not continuous, and there are long periods in which there is no activity. Furthermore, in wireless LANs having access points and clients, access points typically transmit 90% or more of the time during wireless exchanges because downloads to clients are typically much longer in duration than uploads. An upload from a client to an access point is typically a request of a short duration to download to the client. Thus, most of the time access points are transmitting (downloading to clients) and it is unlikely than many access points in a contiguous area are transmitting together, so that all channels within an access point can be transmitted at maximum power for some time. The graph illustrates three transmits from the access point to client (TX) and one receive by the access point from a client (RX) over time period T.

FIG. 5B illustrates a further increase of available bandwidth by expansion of secondary channels into the outer region 404 of a cell 400 for a limited time period. Typically, each access point is connected to another network, for example, through a wired Local Area Network using the Ethernet communication protocol IEEE 802.1. Transmission can be synchronized between the access points because transmission over the wireless network is bursty in nature as discussed in conjunction with FIG. 5A. In order to synchronize transmission between access points, each access point includes a clock. The clocks in each of the access points are periodically synchronized with clocks in adjacent access points in the wireless network over a wired network or the wireless network.

As in conventional systems, if collisions occur between access points, a binary exponential back off mechanism is used. The basic access mechanism is Carrier Sense Multiple Access with Collision Avoidance (CSMA/CA). CSMA/CA works by sensing the medium for activity before every transmission and deferring the transmission if the medium is active. A binary exponential back off mechanism is used to spread transmission opportunities in time and minimize the likelihood of subsequent collisions.

Alternatively, collisions may be avoided in advance by communication between the access points to set up a slotted scheme. For example, the communication can be over a wired backplane. In the slotted scheme, access points agree to transmit at full power on all channels only during certain time slots, and other access points agree not to interfere during those times.

Prior to expanding the secondary channels into the outer region 404, an access point communicates a forecast for a transmission to adjacent access points. The adjacent access points agree not to transmit while the requester access point is transmitting. Having received permission from adjacent access points to transmit, the transmitting access point provides full power to all channels and uses all three channels to simultaneously transmit to the mobile clients. Thus, the secondary channels are transmitted at full power to expand the size of the inner region 406 to cover the entire cell.

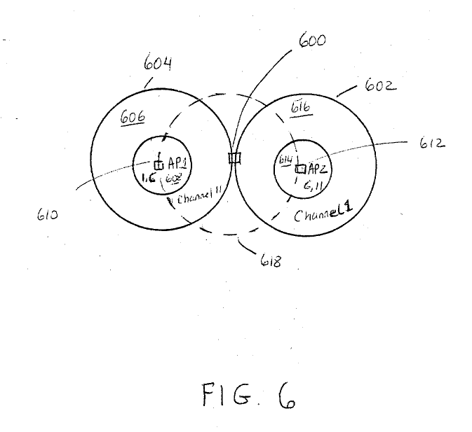

FIG. 6 illustrates the particular case of a client located on the boundary of two cells 604, 602. Cell 604 defines the coverage area for AP1 610 with primary channel 11 in the outer region 606 and secondary channels 1 and 6 in the inner region 608. Cell 602 defines the coverage area for AP2 612 with primary channel 1 in the outer region 616 and secondary channels 6 and 11 in the inner region 614. Cell 618 defines the coverage area of the client 600. The client 600 receives signals of equal strength from the primary channel 11 for AP1 610 and the primary channel 1 for AP2 612, and both AP1 and AP2 receive signals of equal strength from the client 600. Thus the client 600 can communicate with AP1 on primary channel 11 or with AP2 on primary channel 1.

However, transmission from the client to an access point is infrequent and of short duration. Thus, if a collision is detected, the client can easily retransmit. This procedure is defined in the IEEE 802.11b specification for wireless LANs implementing the IEEE 802.11b standard. The transmission from the client can be synchronized and limited to predetermined time slots; for example, the client can be restricted to transmitting when access point AP2 is not transmitting. Typically, access point transmission uses approximately 90% of the available bandwidth. A client on the periphery of an access point cell (AP 1) causes maximum interference to an adjacent cell (AP 2). This situation can be handled in several ways: (1) Retransmission on AP 2 after the receive from the interfering client is effective; (2) Slotted setups whereby a client waits until a slot is available in which they will not cause interference are an alternative if such delays are acceptable, and advantageous in that they do not involve collisions and retransmission.

If there are N (where N is a large number) clients distributed equally around an access point, each client would ideally get 3B/N bandwidth (where B is the bandwidth of a single channel). In an embodiment implementing the IEEE 802.1b, the single channel bandwidth is 11 MB/s. Clients in the outer region 404 around each access point only see one channel, and assuming the outer region 404 contains M (M<N, but can be close to N as the outer region 404 is larger than the inner region 406) clients, they cannot get more than B/M in bandwidth. Clients in the inner region 406 cannot get more than 2B/(N−M) in bandwidth.

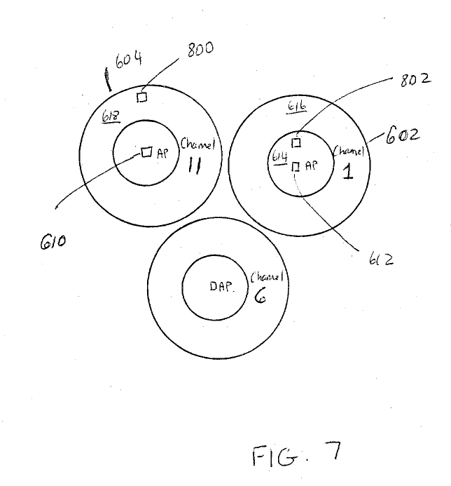

FIG. 7 illustrates a multichannel client 802 located within the inner region of a cell 602 which can perform multichannel communications with the access point. Bandwidth to a client can be further increased through the use of multi-channel clients. If a client has the capability of simultaneous transmission on all three channels, transmission to the access point can be up to three times faster. With both a multichannel client and a multichannel access point, downloads to the client and uploads from the client are three times faster when all three channels are used. The three channels can be used throughout the cell, if there is only one cell in the wireless LAN. If there are multiple cells in the wireless LAN, the three channels can be used simultaneously to upload or download when the client is located in the inner region 614 of the cell. A multichannel client 800 in the outer region 618 of the cell 604 is still restricted to using only the primary channel. There is also a network benefit in that the multichannel client completes the download or upload three times faster which compensates for hogging the bandwidth during this download or upload. Such communication is set up on an ad hoc basis with subsequent back off, upon detecting collisions with other access points or clients, or on a slotted basis, whereby the fast download is planned in advance and other access points and clients are informed as necessary in advance.

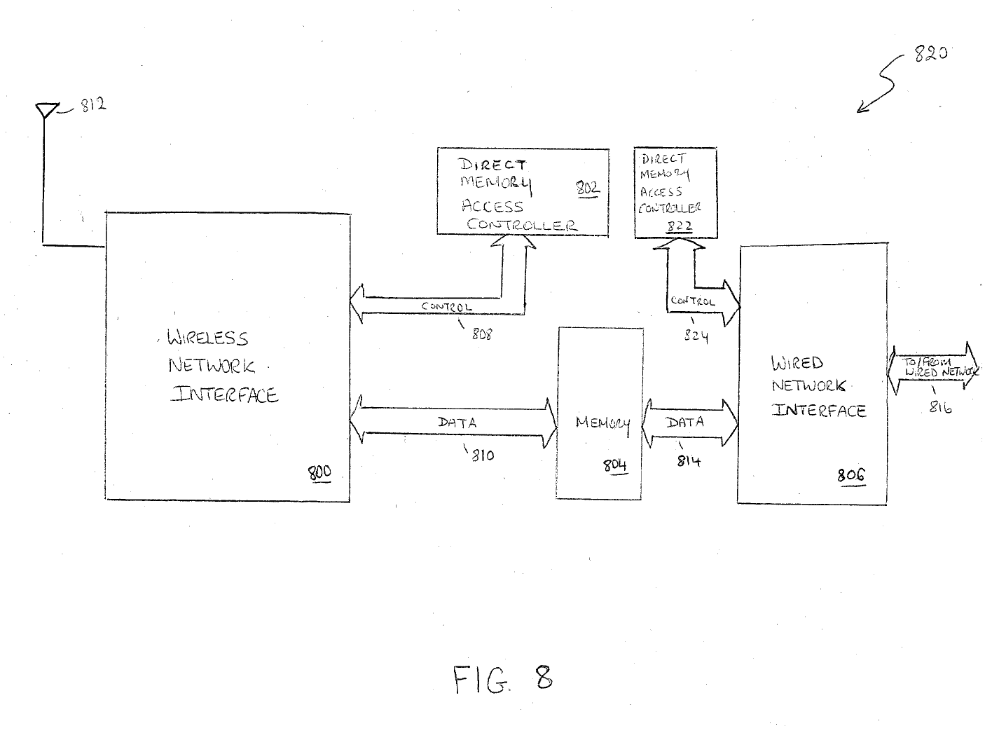

FIG. 8 is a block diagram of a typical access point 820 which performs a bridging function between a wireless network and a wired network. A wireless network interface 800 communicates with remote clients through antenna 812. Data received from the wireless network by the wireless network interface 800 is stored in memory 804, by Direct Memory Access (DMA) Controller 802 through control signals 808, over data bus 810 prior to transferring to the wired network through wired network interface 806.

Data received by the wired network interface from the wired network 816 is stored in memory 804, by Direct Memory Access (DMA) Controller 822 through control signals 824, over data bus 814 prior to being transmitted by the wireless network interface 800 through antenna 812 to the wireless network.

Thus, the access point 820 allows wireless clients to download and upload data from/to clients on a wired network. Access points can communicate over the wired network, for example, to synchronize predetermined transfer periods on the wired network.

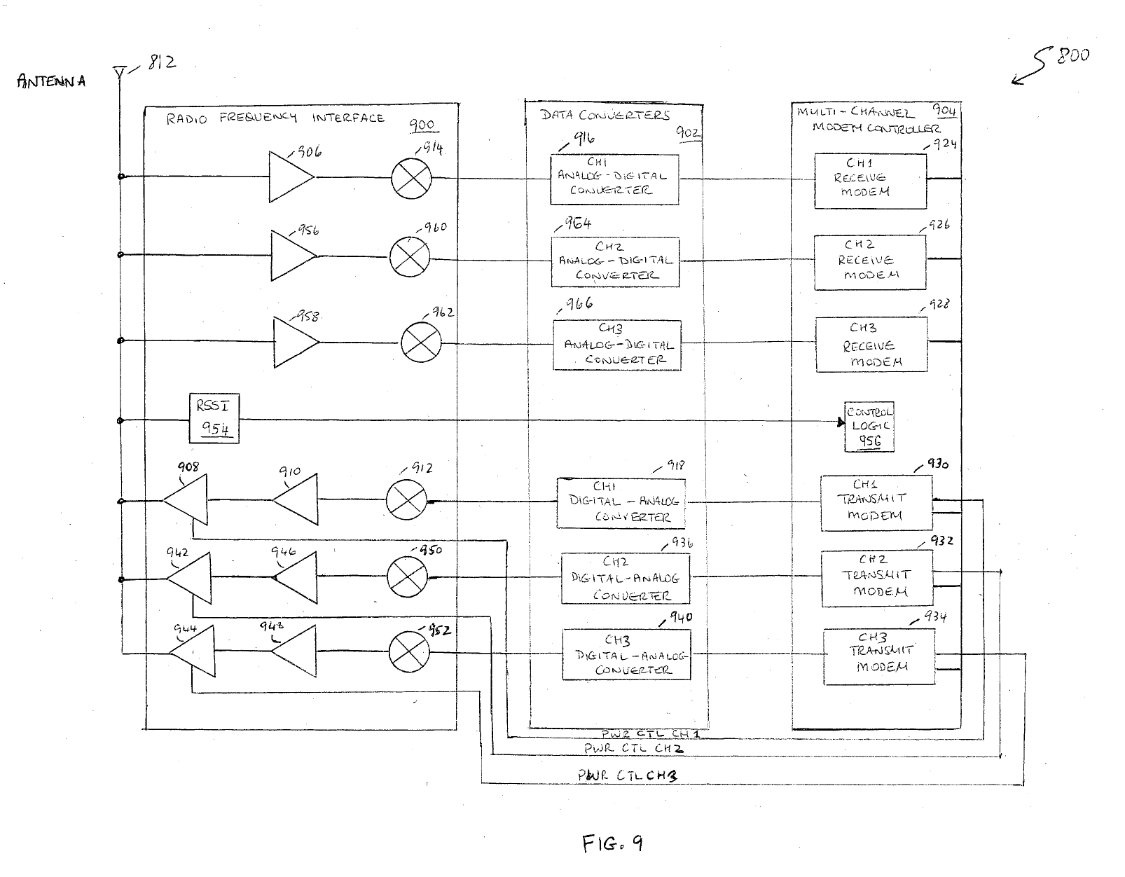

FIG. 9 is a block diagram of an embodiment of the wireless network interface 800 shown in FIG. 8. The wired network interface includes a radio frequency interface 900, an analog-digital and digital to analog conversion circuit 902 and a multi-channel modem/controller 904.

There are three separate receive paths and three separate transmit paths, one receive and transmit path per channel. Signals received by the antenna 812 from mobile clients are coupled to a low noise amplifiers 906, 956, 958. The amplified signals are coupled to down convert mixers 914, 960, 962 which convert high frequency signals to low frequency signals. The amplified and down converted signals are coupled to a respective analog-digital converter 916, 964, 966 in the signal conversion circuit 902 to convert the amplified analog signals to digital signals.

The multi-channel controller 904 includes a respective receive modem 924, 926, 928 per channel and a respective transmit modem 930, 932, 934 per channel. The digital signals output from the analog-digital converters 916, 964, 966 is coupled to a respective receive modem 924, 926, 928 to extract the digital signal from each channel that can be simultaneously transmitted. Each receive modem operates at a different center frequency. For example, in an embodiment for an IEEE 802.11b wireless network, one of the receive modems operates at the center frequency for channel 1, the second operates at the center frequency for channel 6 and the third operates at the center frequency for channel 11.

Downloads to mobile clients on the wireless network originate in the transmit modems 930, 932, 934. Each of the transmit modems 930, 932, 934 is configured to transmit on a different channel having a respective center frequency. Simultaneous transmission on all three channels is permitted. The output of each of the transmit modems 930, 932, 934 is coupled to a respective digital to analog converter 918, 936, 940 for conversion to a respective analog signal to be transmitted over the wireless network through antenna 812.

The analog signals output from each of the digital-analog converters 918, 936, 940 is coupled to a respective up convert mixer 912, 950, 952. A pre-amplifier 910, 946, 948 coupled to the respective up convert mixer 912, 950, 952 amplifies the respective analog signal. Controllable power amplifiers 908, 942, 944 coupled to the respective outputs of the pre-amplifiers 910, 946, 948 further amplify the analog signals based on the value of a respective power control signal PWR CTL CH1-CH3. Each transmit modem 930, 932, 934 includes power control logic which controls the power of the transmitted analog signal for each channel through the respective power control signal. Thus, in the case of access point (shown in FIG. 4) with channels 1 and 11 transmitted at half power and channel 6 transmitted at full power, the power control signals control the output of power amplifiers 908, 942, 944 such that the signal strength of analog signals transmitted for channels 1 and 11 is half the power of signals transmitted for Channel 6.

The radio frequency interface 900 also includes a Received Signal Strength Indication Circuit (RSSI) 954 coupled to the antenna 812 for detecting strength of received signals. The received signal power can also be measured in the receive modems 924, 926, 928, if the analog-digital converters 916,960, 962 have sufficient dynamic range.

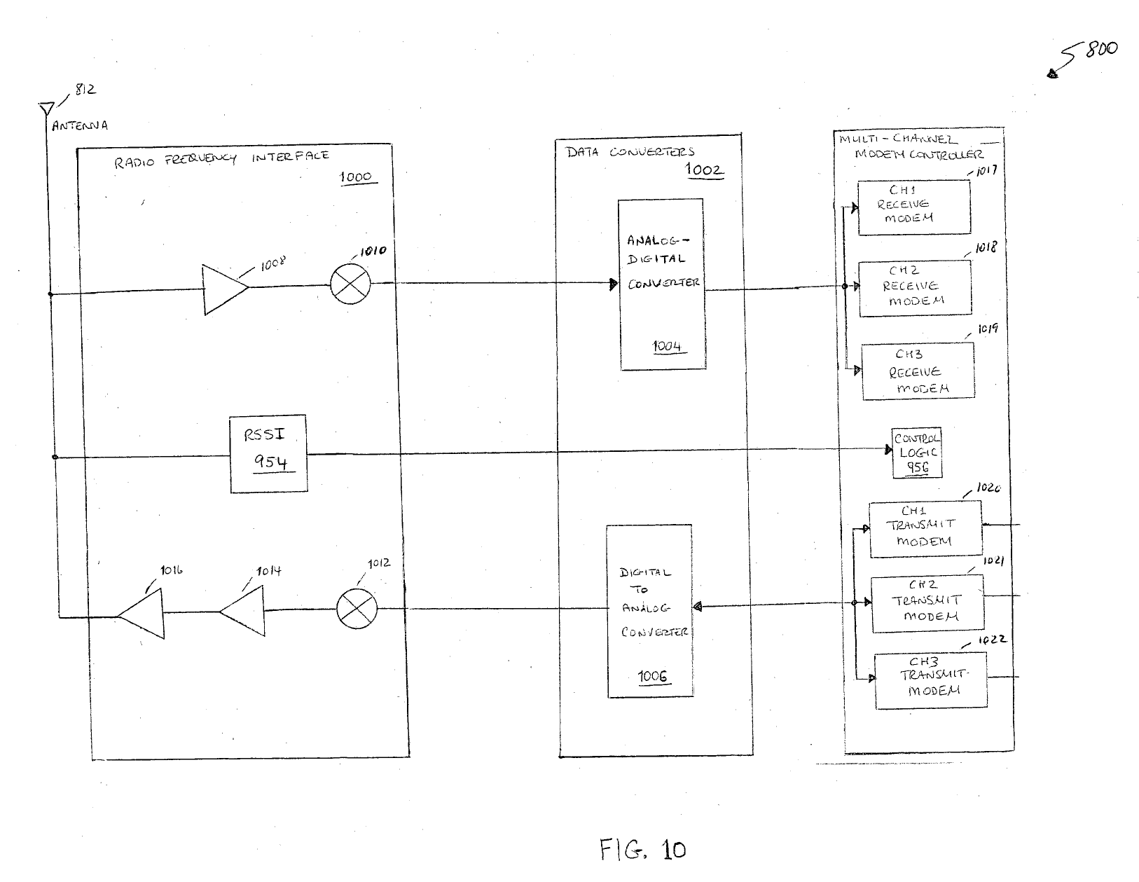

FIG. 10 is a block diagram of another embodiment of the wireless network interface 800 shown in FIG. 8. The wired network interface includes a radio frequency interface 1000, an analog-digital and digital to analog conversion circuit 1002 and a multi-channel modem/controller 904.

Signals received by the antenna 812 from mobile clients are coupled to a low noise amplifier 906. The amplified signals are coupled to a down convert mixer 914 which converts high frequency signals to low frequency signals. The amplified and down converted signal is coupled to an analog-digital converter 916 in the signal conversion circuit 902 to convert the amplified analog signal to a digital signal.

The multi-channel controller 904 includes a respective receive modem 1017, 1018, 1019 per channel and a respective transmit modem 1020, 1021, 1022 per channel. The digital signal output from the analog-digital converter 916 is coupled to each of the receive modems 1017, 1018, 1019 to extract the digital signal from each channel that can be simultaneously transmitted. Each receive modem operates at a different center frequency. For example, in an embodiment for an IEEE 802.11b wireless network, one of the receive modems operates at the center frequency for channel 1, the second operates at the center frequency for channel 6 and the third operates at the center frequency for channel 11.

Downloads to mobile clients on the wireless network originate in the transmit modems. Each of the transmit modems 1020, 1021, 1022 is configured to transmit on a different channel having a respective center frequency. Simultaneous transmission on all three channels is permitted. The output of each of the transmit modems 1020, 1021, 1022 is coupled to the digital to analog converter 1006 for conversion to an analog signal to be transmitted over the wireless network through antenna 812.

The analog signal output the digital-analog converter 1006 is coupled to an up convert mixer 1012. A pre-amplifier 1014 coupled to the up convert mixer 1012, 950, 952 amplifies the respective analog signal. Power amplifier 1016 coupled to the output of the pre-amplifier 1014 further amplifies the analog signal. The signal power is controlled by varying the output strength of the signals output from the transmit modems 1020, 1021, 1022. In the embodiment shown, a separate power control is not needed because the digital-analog converter 1006 has sufficient dynamic range. The radio frequency interface 900 also includes a Received Signal Strength Indication Circuit (RSSI) 954 coupled to the antenna 812 for detecting strength of received signals.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless access system comprising:
multiple cells, each having one or more primary channels with adjacent cells having different primary channels; and
within a cell, an access point transmitting on the one or more primary channels and at lesser power on a secondary channel exclusive of the primary channel, the access point assigning channels to wireless clients.

2. The wireless access system of claim 1 wherein the access point senses relative distance of clients and assigns secondary channels to closer clients.

3. The wireless access system of claim 2 wherein the access point senses power to sense relative distance.

4. The wireless access system of claim 1 wherein clocks in each access point are synchronized.

5. The wireless access system of claim 4 wherein the access point expands the secondary channels to fill the cell for a limited time agreed upon with other access points.

6. The wireless access system of claim 5 wherein the access point retransmits, upon detecting a collision of its transmission with transmissions from the client or another access point.

7. The wireless access system of claim 5 wherein the client retransmits, upon detecting a collision of its transmission with transmissions from another client or the access point.

8. The wireless access system of claim 7 wherein collisions are reduced by limiting transmission by the client to a pre-determined time slot.

9. The wireless access system of claim 1 wherein a multichannel client is restricted to primary channels in an outer region of the cell.

10. The wireless access system of claim 9 wherein the multi channel client transmits over all available channels simultaneously.

11. A method for increasing bandwidth in a wireless access system comprising the steps of:
assigning different primary channels to adjacent cells;
within a cell, transmitting from the primary channel and at lesser power on a secondary channel exclusive of the primary channel; and
assigning channels to wireless clients.

12. The method of claim 11 wherein the step of assigning further comprises:
sensing relative distance of clients; and
assigning secondary channels to closer clients.

13. The method of claim 12 wherein the step of sensing further comprises:
sensing power to sense relative distance.

14. The method of claim 11 wherein clocks in each access point are synchronized.

15. The method of claim 14 further comprising:
expanding the secondary channels to fill the cell for a limited time agreed with other access points.

16. The method of claim 15 further comprising:
re-transmitting by the access point, upon detecting a collision of its transmission with transmission from another access point or the client.

17. The method of claim 15 further comprising:
re-transmitting by the client, upon detecting a collision of its transmission with transmission from another client or the access point.

18. The method of claim 16 further comprising:
limiting transmission by the client to predetermined time slots to reduce collisions.

19. The method of claim 11 wherein a multichannel client is restricted to primary channels in an outer region of the cell.

20. The method of claim 19 wherein the multi channel client transmits over all available channels simultaneously.
